(19) United States
(12) Patent Application Publication
(10) Pub. No.: US 2015/0252948 A1
(43) Pub. Date: Sep. 10, 2015

(54) Device for Evaporating Low-Boiling Liquefied Gases

(71) Applicant: Marine Service GmbH, Hamburg (DE)

(72) Inventors: Jochen Schmidt-Lüssmann, Buchholz (DE); Jan-Christian Müller-Rieck, Hamburg (DE)

(73) Assignee: Marine Service GmbH

(21) Appl. No.: 14/629,128

(22) Filed: Feb. 23, 2015

(30) Foreign Application Priority Data
Feb. 25, 2014 (DE) 102014102473.7

(51) Int. Cl. F17C 9/02

(52) U.S. Cl. CPC F17C 9/02; F17C 2270/0581; F17C 2227/0323

(57) ABSTRACT

The invention relates to a device for evaporating low-boiling liquefied gases, in particular for use in an internal combustion engine on a ship, wherein the gas is heated by means of a heating medium circulating in an intermediate circuit. According to the invention, the first heat exchanger (1) is designed as a double-tube heat exchanger with an inner tube (14) for conducting and heating the gas and with an outer tube (15) for conducting the heating medium, wherein the gas and the heating medium are fed synchronously through the first heat exchanger (1), and the inner tube (14) and the outer tube (15) of the first heat exchanger (1) are formed concentrically and directed vertically.

The invention relates to a device for evaporating low-boiling liquefied gases according to the preamble of claim 1, in particular for use in an internal combustion engine on a ship.

Liquid gases, in particular liquefied natural gas (LNG) which is transported in cryogenic storage tanks on the ship at a temperature of below minus 160° C. and which has to be heated up to a temperature of approx. plus 30° C. and evaporated for the use in the main engine, are increasingly used for operating main engines of large ships such as tankers, container ships etc. Liquid gas propulsion is particularly suitable if the ship is already used as a gas transport ship, but also in cases of voyages in coastal waters where high environmental standards have to be met. However, during coastal operation there is the problem that the ship often sails in half-load operation or under changing load conditions and therefore the fuel consumption is unsteady.

For heating and evaporating the liquid gas, seawater or a heating medium that remains liquid at low temperatures, in particular a glycol-water mixture or another alcohol-water mixture, is used, which heats the liquid gas in an intermediate circuit. Seawater has the disadvantage that freezing can easily occur if the water circulation is insufficient. Moreover, the susceptibility to corrosion of heat exchangers is very high when using seawater.

A shell and tube heat exchanger, in which seawater flows in counterflow around a multiplicity of vertically directed tubes through which LNG is fed, is known from EP1762639A1. This publication is substantially concerned with the problem of corrosion resistance of the tubes used.

DE3626359C2 describes an evaporator for evaporating a liquid gas product, such as LNG, in which a tube that is wound spirally around a core tube is arranged in a liquid bath in which steam is blown in via a steam injector. Excessive steam or excessive condensate is fed back into a liquid container and evaporated again. The problem of mechanical stress during rapid load changes can be slightly reduced in this manner; however, a plurality of steam supply systems, which have to be connected and disconnected depending on the load, have to be used for covering a wide load range. Uniform heating of LNG that is adapted to significant load changes can be achieved in this manner only with significant constructional efforts which often are faulty and are difficult to control during operation.

It is therefore an object of the invention to propose a device for evaporating low-boiling liquefied gases, in particular for use in an internal combustion engine on a ship, which is constructed in a simple manner, is mechanically insensitive and can also be used under significantly and rapidly changing load conditions.

This object is achieved by the invention specified in claim 1. Advantageous refinements of the invention are specified in sub-claims.

The invention is based on a device of the kind specified in the preamble of claim 1, in which heating the gas is carried out by means of a heating medium, in particular a glycol-water mixture, which is carried in an intermediate circuit and which, in turn, is heated via a second heat exchanger comprising another heating medium.

According to the invention, the first heat exchanger is designed as a double-tube heat exchanger, wherein the gas to be heated is fed through an inner tube and the heating medium is fed through between the inner tube and an outer tube that concentrically surrounds the inner tube. The double-tube heat exchanger is directed vertically and the gas and the heating medium are fed synchronously through the first heat exchanger.

The unidirectional flow of gas and heating medium reduces the risk of ice crystal formation in the heating medium because it has its highest temperature at the coldest point of the evaporator tube. The vertical construction avoids stratified flows, wavy flows and slug flows. Also, complete wetting takes place in the boiling region of the tube walls so that optimal heat exchange is also provided in the boiling region.

The diameter of the inner tube for conducting the gas preferably widens from a first lower diameter to a second larger upper diameter, wherein gas is fed into the heat exchanger at the lower end of the inner tube. The diameter of the outer tube preferably follows equidistantly the path of the inner tube. In this way it can be achieved that by suitably dimensioning the degree of the diameter increase, the flow velocity in the inner tube remains substantially unchanged during the boiling process.

The inflow of gas into the lower end of the first heat exchanger takes place with a small volume of the liquid gas due to the relatively small tube diameter provided there. In the case of major load changes and a pressure increase in the fuel line at the exit of the device according to the invention, the liquid gas from the first heat exchanger present in the inner tube is pushed back, wherein due to the relatively small volume of the liquid phase, no re-evaporation takes place during rapid load changes such as, e.g., rapid stopping maneuvers of the ship.

The inner and outer tubes can be fabricated as a stepped construction with cylindrical segments and conical segments arranged therebetween. In this way, the flow velocity of the heating medium in the cylindrical segments is kept constant and good heat transfer is ensured.

The outer and inner tubes are preferably spaced apart from one another along the length of the heat exchanger by means of a plurality of spacers. These spacers can be formed at the same time as guide plates so as to achieve a swirling flow of the heating medium, whereby improved heat transfer can be achieved.

The device according to the invention preferably also includes a re-heater via which the liquid gas leaving the first heat exchanger is heated further. The re-heater is likewise heated via a heating medium, such as a glycol-water mixture, which, as in the first heat exchanger, preferably flows synchronously with the gas to be heated through the re-heater.

The re-heater is in particular designed as a U-shaped double-tube heat exchanger with the outer and inner tubes running vertically, cylindrically and concentrically.

It is preferred to use the same heating medium for the first heat exchanger as well as for the re-heater, wherein it is fed first to the re-heater in which it synchronously reheats the gas leaving the first heat exchanger. The heating medium is then fed to the lower end of the first heat exchanger in which it synchronously heats the liquid gas fed from the liquid gas tank.

It can be provided to provide a connection in the connection line between the heat exchanger and the re-heater for feeding in of boil-off gas from the liquid gas tank so as to be able to immediately utilize liquid gas that is already present in gaseous form without causing retroactive effects on the evaporation process in the first heat exchanger.

In order to avoid or reduce thermal stress in the outer tube of the first heat exchanger, a length compensator, for example a corrugated tube section, can be inserted at the lower end thereof. Moreover, the conical tube segments in the path of the inner and outer tubes of the first heat exchanger also serve for reducing thermal stresses. In the re-heater tube, the formation as a U-shaped tube serves in particular for avoiding thermal stresses. The tube bends in the inlet of the re-heater and at the lower deflection help to re-evaporate liquid residues on the walls of the re-heater that have not evaporated yet in the first heat exchanger.

The synchronous flow of the liquid gas and the heating medium in the first heat exchanger as well as in the re-heater reduces the dependency of the outlet temperature on the load point of the ship's main engine that needs to be supplied.

The modular structure of the device according to the invention permits connecting a plurality of such devices in parallel. Using standardized cylindrical and conical tube segments enables simple foundation, simplified maintenance and cost-effective fabrication.

The invention is explained in greater detail below by means of an exemplary embodiment. In the figures:

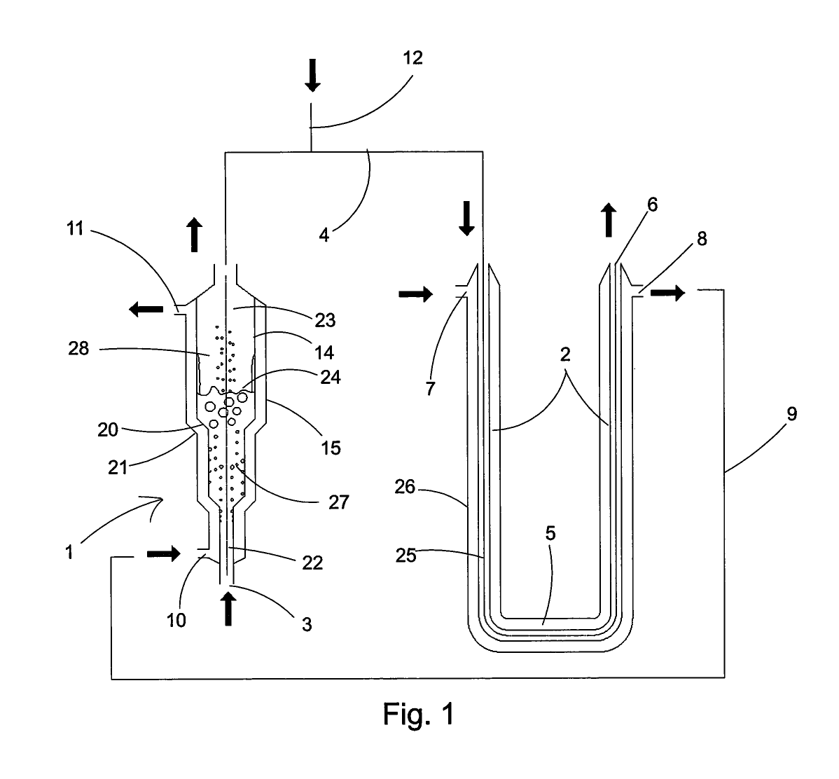

FIG. 1 shows a schematic view of the invention,

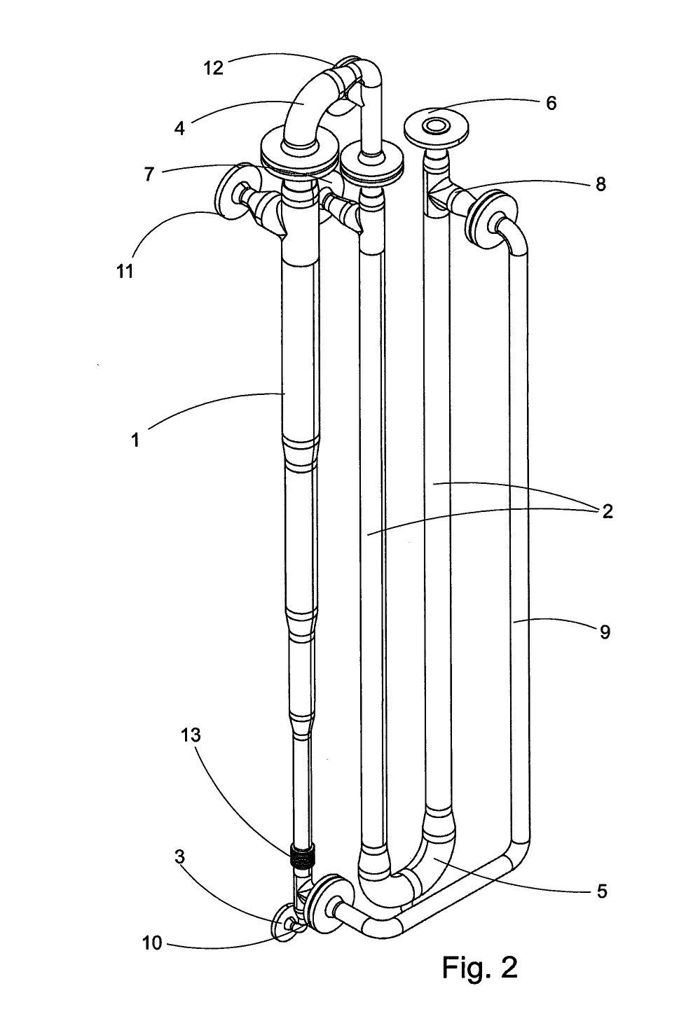

FIG. 2 shows a perspective view of an embodiment of the invention,

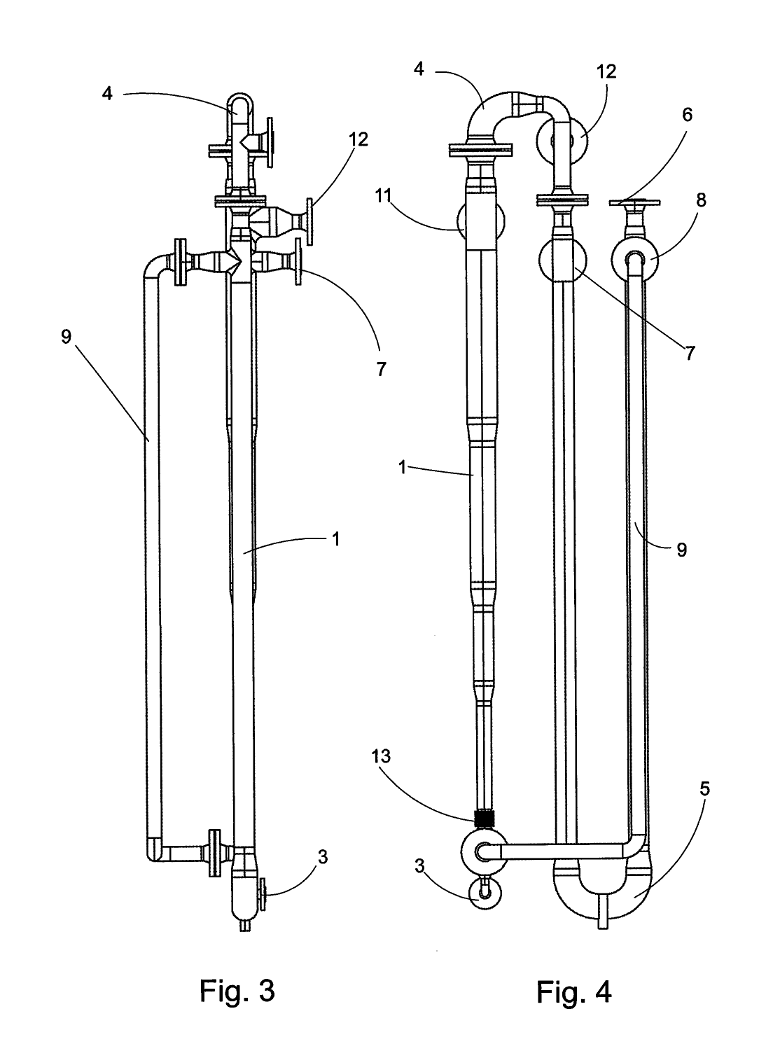

FIG. 3 shows a side view of the subject matter of FIG. 2,

FIG. 4 shows a front view of the subject matter of FIG. 2,

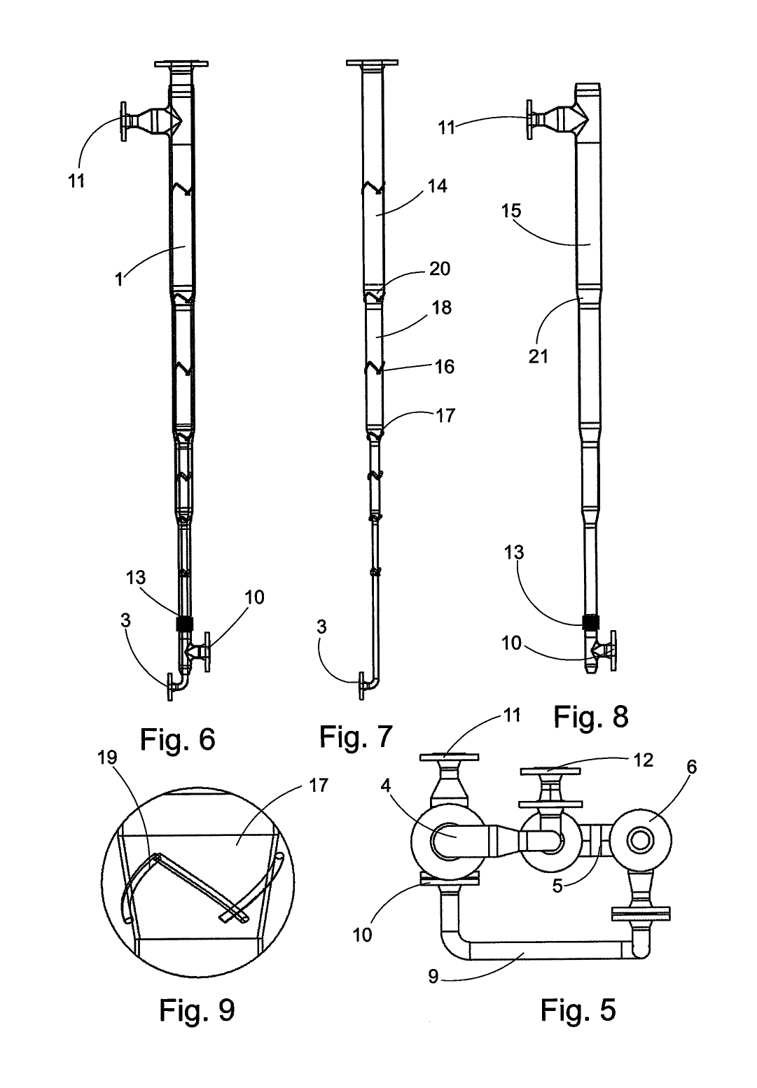

FIG. 5 shows a top view of the subject matter of FIG. 2,

FIG. 6 shows a sectional view of a double-tube heat exchanger,

FIG. 7 shows a side view of an inner tube,

FIG. 8 shows a side view of an outer tube,

FIG. 9 shows a detailed view of a conical tube segment of the inner tube.

The subject matter of the invention illustrated in FIG. 1 includes a first heat exchanger 1 that is substantially formed from an inner tube 14 and an outer tube 15. The inner tube 14 as well as the outer tube 15 are formed from a plurality of cylindrical tube segments, each of which are connected to one another via conically extending tube segments 20 and 21. Overall, for the first heat exchanger, this results in a stepped double-tube heat exchanger that substantially widens conically in the upward direction.

Liquid low-boiling gas 22, such as LNG, is introduced into the first heat exchanger 1 via the lower LNG inlet 3. A glycol-water mixture is introduced into the intermediate space between the inner tube 14 and the outer tube 15 via the connection 10, wherein the glycol-water mixture, while flowing through the heat exchanger, heats the liquid gas to the extent that nucleate boiling takes place in the region 27, and subsequent to the transition zone 24, in which film boiling takes place, mist boiling occurs in the region 28, and thereafter the gas leaves the heat exchanger 1 as vaporous gas 23.

The vapor 23 leaves the first heat exchanger 1 through an upper tube bend 4 that is provided with a connection 12 for optionally feeding boil-off gas and then enters from above the inner tube 25 of a re-heater 2 into which, via a heating medium inlet 7, a glycol-water mixture is fed between the outer tube 26 and the inner tube 25 thereof, which glycol-water mixture is in heat exchange with a further heating medium, in particular seawater, via a second heat exchanger (not shown) in the circuit.

The heating medium flows synchronously with the gas to be heated through the re-heater 2. The gas leaves the re-heater via the gas outlet 6 while the heating medium leaves the re-heater 2 via the outlet 8 and is guided via the line 9 to the connection 10 of the first heat exchanger 1 from where it is discharged at the upper end of the first heat exchanger via the heating medium outlet 11 and is fed back to the second heat exchanger (not shown).

FIG. 2 shows an implemented perspective view of the device according to the invention. The first heat exchanger 1 is connected to a storage tank for liquid gas via the LNG inlet 3. The gas is heated in the heat exchanger by the heating medium fed via the connection 10 and then it flows in the gaseous state through the tube bend 4 into the upper end of the U-shaped re-heater 2, the vertical side pieces of which are connected to one another at the lower end via the tube bend 5. Discharging the evaporated and heated gas takes place via the gas outlet 6 at the end of the U-shaped re-heater 2. The gas is conveyed from the gas outlet 6 to a main engine of a ship.

For further clarification of the device according to the invention, the FIGS. 3, 4 and 5 show a side view, a front view and a top view onto the subject matter of FIG. 2. These figures show in particular the connection 12 for a boil-off gas inlet via which boil-off gas available in the storage tank can be introduced directly into that region of the device in which the fed liquid gas is already substantially evaporated.

FIG. 6 shows a sectional view through the first heat exchanger. The later has a plurality of, in particular four, cylindrical segments which are connected to one another via three conical segments. Between the outer and the inner tube there are spacers for maintaining the spacing between outer and inner tubes and, at the same time, for generating a swirling flow of the heating medium.

FIG. 7 shows the inner tube 14 of the first heat exchanger which is composed of a plurality of cylindrical segments 18 so as to form a tube string, wherein the cylindrical segments are welded together via conically extending segments 17 and 20, respectively. A plurality of spacers 16 and 19, which project from the surface obliquely to the longitudinal axis, are welded onto the outside, which spacers ensure that the spacing between the inner and outer tubes is maintained even in the case of thermal expansions, and which, at the same time, deflect and swirl the heating medium flow so as to improve the heat transfer to the liquid gas in the inner tube.

FIG. 8 shows the outer tube 15 which, in the lower region, has a length compensator 13 in the form of a corrugated tube section so as to be able to compensate thermal length variations of the heat exchanger during operation.

FIG. 9 shows an enlarged view of a conical segment 17 with a spacer 19 welded thereon, which spacer is composed of guide plates which are each arranged alternately at approximately 45° on the outer circumference of the segment and which are fixedly welded to said segment. Corresponding spacers 16 can also be arranged in the cylindrical regions of the first heat exchanger and in the re-heater.

The device according to the invention can be accommodated with minimum space requirements in particular in the so-called gas processing chamber of a ship. The raw material used is in particular cold-resistant austenitic steel (V2A or V4A).

With the device according to the invention, LNG gas stored in the storage tank at approximately −162° C. can be heated in the first heat exchanger to approximately −40° C. and in the re-heater to approximately +30° C. This two-staged heating significantly reduces thermal loads of the materials used. The specific configuration of the first heat exchanger helps to respond to load changes of a consumer better than in the prior art.

### REFERENCE LIST

1 first heat exchanger
2 re-heater
3 LNG inlet
4 upper bend
5 lower bend
6 gas outlet
7 heating medium inlet
8 outlet
9 tube
10 connection
11 heating medium outlet
12 boil-off gas inlet
13 length compensator
14 inner tube
15 outer tube
16 spacer
17 conical segment
18 cylindrical segment
19 spacer
20 conical inner tube segment
21 conical outer tube segment
22 liquid LNG
23 vaporous LNG
24 transition zone
25 inner tube
26 outer tube
27 region
28 region

1. A device for evaporating low-boiling liquefied gases, wherein the gas is heated via a first heat exchanger (1) by means of a heating medium, circulating in an intermediate circuit, and the heating medium, on its part, is heated via a second heat exchanger by means of a further heating medium, characterized in
that the first heat exchanger (1) is designed as a double-tube heat exchanger with an inner tube (14) for conducting and heating the gas, and with an outer tube (15) for conducting the heating medium,
the gas and the heating medium are fed synchronously through the first heat exchanger (1),
that the inner tube (14) and the outer tube (15) of the first heat exchanger (1) are formed concentrically and directed vertically, and
that the diameter of the inner tube (14) for conducting the gas widens from a first lower diameter to a second larger upper diameter.

2. (canceled)

3. The device according to claim 1, characterized in that the diameter of the inner tube (14) widens in steps from the first to the second diameter.

4. The device according to claim 3, characterized in that the diameter of the outer tube (15) follows the diameter of the inner tube (14) at a distance from the inner tube.

5. The device according to claim 1, characterized in that spacers for deflecting the flow of the heating medium are inserted between the outer tube (15) and the inner tube (14).

6. The device according to claim 3, characterized in that the transitions between the diameter steps of the inner and/or outer tubes are formed by conical tube segments (20, 21) that are inserted between cylindrical tube segments (18).

7. The device according to claim 1, characterized in that downstream of the first heat exchanger (1), a re-heater (2) is arranged via which gas heated in the first heat exchanger (1) is reheated by heat exchange with a heating medium, before the heated gas is fed to the internal combustion engine.

8. The device according to claim 7, characterized in that the re-heater (2) is designed as a vertically directed U-shaped double-tube heat exchanger.

9. The device according to claim 7, characterized in that the heating medium, is successively fed first through the re-heater (2) and then through the first heat exchanger (1) in each case synchronously with the gas.

10. The device according to claim 7, characterized in that the connection line (4) between the inner tube (14) of the first heat exchanger (1) and the re-heater (2) for the gas is provided with a connection (12) for feeding in boil-off gas from a gas storage tank.

11. (canceled)

12. The device according to claim 3, characterized in that spacers for deflecting the flow of the heating medium are inserted between the outer tube (15) and the inner tube (14).

13. The device according to claim 4, characterized in that spacers for deflecting the flow of the heating medium are inserted between the outer tube (15) and the inner tube (14).

14. The device according to claim 4, characterized in that the transitions between the diameter steps of the inner and/or outer tubes are formed by conical tube segments (20, 21) that are inserted between cylindrical tube segments (18).

15. The device according to claim 8, characterized in that the heating medium, is successively fed first through the re-heater (2) and then through the first heat exchanger (1) in each case synchronously with the gas.

16. The device according to claim 8, characterized in that the connection line (4) between the inner tube (14) of the first heat exchanger (1) and the re-heater (2) for the gas is provided with a connection (12) for feeding in boil-off gas from a gas storage tank.

17. The device according to claim 9, characterized in that the connection line (4) between the inner tube (14) of the first heat exchanger (1) and the re-heater (2) for the gas is provided with a connection (12) for feeding in boil-off gas from a gas storage tank.

18. The device according to claim 1, characterized in that it is used in an internal combustion engine on a ship.

19. The device according to claim 1, characterized in that the heating medium circulating in the intermediate circuit is a glycol-water mixture.
